(19) United States
(12) Patent Application Publication
(10) Pub. No.: US 2003/0067624 A1
(43) Pub. Date: Apr. 10, 2003

(54) System and method for mobile printing

(76) Inventors: Jeff M. Anderson, Camas, WA (US); David M. Hall, Camas, WA (US); David Staas, Camas, WA (US)

Correspondence Address: HEWLETT-PACKARD COMPANY, Intellectual Property Administration, P.O. Box 272400, Fort Collins, CO, 80527-2400, US

(21) Appl. No.: 09/974,390

(22) Filed: Oct. 10, 2001

(51) Int. Cl. G06F 13/00; G06F 15/00; G06F 3/12; H04B 1/38

(52) U.S. Cl. 358/1.15; 455/556

(57) ABSTRACT

Various systems, methods, and programs embodied in computer readable mediums are provided relating to mobile printing. In one embodiment, a printing method is provided that comprises the steps of establishing a data communications link between a mobile printer connector and a printer and transmitting an email with an attachment for printing to a mobile print connector service. The method further comprises the steps of receiving the attachment embodied in a format recognizable by the printer in the mobile printer connector, and relaying the attachment embodied in the format recognizable by the printer from the mobile printer connector to the printer for printing.

### CROSS REFERENCE TO RELATED APPLICATIONS

This application is related to co-pending U.S. patent application entitled “System and Method for Mobile Printing”, filed on Jun. 18, 2001 and assigned Ser. No. 09/884,594; co-pending U.S. patent application entitled “System and Method for Walk-up Printing”, filed on Jun. 18, 2001 and assigned Ser. No. 09/884,318; co-pending U.S. patent application entitled “Rendering Broker Service and Method”, filed on Jun. 18, 2001 and assigned Ser. No. 09/884,593; co-pending U.S. patent application entitled “System and Method for Remote Document Retrieval”, filed on Jun. 18, 2001 and assigned Ser. No. 09/884,600; co-pending U.S. patent application entitled “System and Method for Automated Rendering to Print to a File”, filed on Jun. 18, 2001 and assigned Ser. No. 09/884,249; and co-pending U.S. patent application entitled “System and Method for Configuring a Printing System”, filed on Jun. 18, 2001 and assigned Ser. No. 09/884,598, each of the above referenced patent applications being incorporated herein by reference in their entirety.

### TECHNICAL FIELD

The present invention is generally related to the field of printing and, more particularly, is related to a system and method for mobile printing. cl BACKGROUND OF THE INVENTION

Recent years have seen a proliferation of portable electronic devices such as personal digital assistants (PDA's), cellular telephones, and/or other portable electronic devices. For example, personal digital assistants are now available such as the HP Jornada manufactured by Hewlett-Packard Company based in Palo Alto, Calif., or the Blackberry® manufactured by Research in Motion® Limited based in Ontario, Canada as well as other brands. These mobile devices offer a range of capabilities, including mobile calendars, organizing capabilities, and electronic mail (email) received and transmitted via a mobile pager network or other mobile networks, etc.

Unfortunately, these devices are typically limited in their capabilities due to the fact that they are limited in their processing capacity and memory size. For example, many such devices cannot execute the many different applications that are available for the average personal computer. Specifically, such devices may not be able to implement word processors or other extensive applications.

When it comes to activities such as printing, etc., such devices typically are unable to perform various tasks such as rendering documents into printer compatible form, etc. This fact can negatively impact the usefulness of such devices. For example, a user may find themselves in the situation where they are standing in front of a printer with their personal digital assistant in hand and a document stored thereon that they wish to print. Unfortunately, in such a circumstance, the user may be prevented from printing a document on the printer due to the limited capability of the personal digital assistant and the lack of connectivity between the printer and the personal digital assistant.

In yet another situation, a user may have a laptop computer that has the computing capacity to perform the tasks necessary to print a document. However, the user may be in a location where they do not have access to their usual printer. In such a case, the user may be prevented from printing to any available printer because it is a different model that requires a rendering service or printer specific driver that is not stored on their laptop.

### SUMMARY OF THE INVENTION

In view of the forgoing, the present invention provides for various systems, methods, and programs embodied in computer readable mediums relating to mobile printing. In one embodiment, a printing method is provided that comprises the steps of establishing a data communications link between a mobile printer connector and a printer and transmitting an email with an attachment for printing to a mobile print connector service. The method further comprises the steps of receiving the attachment embodied in a format recognizable by the printer in the mobile printer connector, and relaying the attachment embodied in the format recognizable by the printer from the mobile printer connector to the printer for printing.

In another embodiment, the present invention provides for a mobile printer connector. In this respect, the mobile printer connector comprises a processor circuit having a processor and a memory with a wireless transceiver and a printer interface coupled to the processor circuit. The mobile printer connector also comprises mobile print logic stored in the memory and executable by the processor. The mobile print logic comprises logic that establishes a data communications link with a printer, logic that establishes a print session with a mobile print connector service, and, logic that relays a document received via the wireless transceiver to the printer via the printer interface.

In still another embodiment, the present invention provides for a method to facilitate mobile printing. In this respect, the present method comprises the steps of receiving in a server an email with an attachment that is to be printed, identifying a mobile printer connector designated as a print receptor for the attachment, obtaining a rendered version of the attachment for printing, and, transmitting the rendered version of the attachment to the mobile printer connector for printing.

In yet another embodiment, the present invention provides for a program embodied in a computer readable medium that facilitates mobile printing. In this respect, the program comprises code that identifies a mobile printer connector designated as a print receptor for an attachment to an email received from a sending device, wherein the attachment is to be printed, code that obtains a rendered version of the attachment for printing, and, code that transmits the rendered version of the attachment to the mobile printer connector for printing.

Other features and advantages of the present invention will become apparent to a person with ordinary skill in the art in view of the following drawings and detailed description. It is intended that all such additional features and advantages be included herein within the scope of the present invention.

### BRIEF DESCRIPTION OF THE SEVERAL VIEWS OF THE DRAWINGS

The invention can be understood with reference to the following drawings. The components in the drawings are not necessarily to scale. Also, in the drawings, like reference numerals designate corresponding parts throughout the several views.

FIG. 1 is a block diagram of a mobile printing network according to an embodiment of the present invention;

FIG. 2 is a flow chart of a mobile print service implemented in the mobile print server of FIG. 1;

FIG. 3 is a flow chart of a mobile print logic implemented in the mobile printer connector of FIG. 1; and

FIG. 4 is a flow chart of an automated print agent implemented in the mobile print server of FIG. 1.

### DETAILED DESCRIPTION OF THE INVENTION

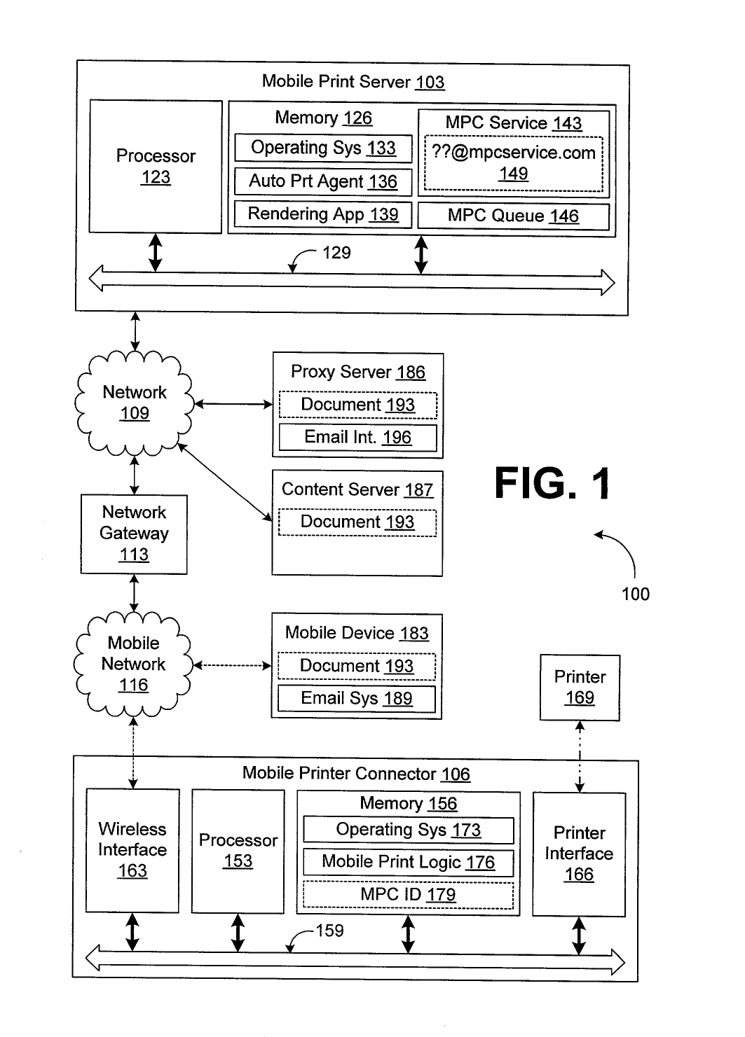

With reference to FIG. 1, shown is a mobile printing network 100 according to an embodiment of the present invention. For the convenience of the reader, the following discussion begins with physical description of the mobile printing network 100 followed by a discussion of the operation and usage thereof. Thereafter, a more detailed discussion of the various components contained within the mobile printing network 100 is provided with reference to later figures.

The mobile printing network 100 includes a mobile print server 103 and a mobile printer connector (MPC) 106. A data communications link may be established between the mobile printing server 103 and the MPC 106 through network 109, network gateway 113, and a mobile network 116. The network 109 includes, for example, the Internet, wide area networks (WANs), local area networks, wireless networks, or other suitable networks, etc., or any combination of two or more such networks. The mobile print server 103 is coupled to the network 109 to facilitate data communication to and from the network 109 as is generally known by those of ordinary skill in the art. In this respect, the mobile print server 103 may be linked to the network 109 through various devices such as, for example, network cards, modems, or other such communications devices, etc.

The mobile network 116 may comprise, for example, a wireless network such as a cellular network, pager network, or other wireless network. The network gateway 113 serves to link the mobile network 116 with the network 109. Since the network 109, the network gateway 113, and the mobile network 116 comprise conventional data communications technology, a detailed discussion of each is not included herein.

Alternatively, in another embodiment, the mobile printer connector 106 may be directly coupled to the network 109 via a hardwire connection, thereby bypassing the mobile network 116 and the network gateway 113 entirely.

The mobile print server 103 includes a processor circuit having a processor 123 and a memory 126, both of which are coupled to a local interface 129. In this respect, the local interface 129 may be, for example, a data bus with accompanying control/address bus as is generally understood by those with ordinary skill in the art. Thus, the mobile print server 103 may be, for example, a computer system or other device with like capability. The mobile print server 103 also includes several components that are stored in the memory 126 and are executable by the processor 123. These components include an operating system 133, an automated print agent 136, a rendering application 139, a mobile print connector (MPC) service 143, and a mobile printer connector queue 146. Associated with the MPC service 143 is a destination address 149 to which items may be sent as will be described. The mobile print server 103 is an example of the many different servers that are coupled to the network 109.

The mobile printer connector (MPC) 106 also includes a processor circuit having a processor 153 and a memory 156, both of which are coupled to a local interface 159. In this respect, the local interface 159, may be, for example, a data bus with accompanying control/address bus as can be appreciated by those with ordinary skill in the art. Thus, the MPC 106 may comprise, for example, a computer system, personal digital assistant, or other device with the processor circuit included therein.

The MPC 106 includes a wireless interface 163 that facilitates transmitting and receiving data to and from the mobile network 116. In this respect the wireless interface 163 may comprise, for example, an appropriate transceiver or other such device with like capability, etc., that provides for communication with a cellular or pager network, etc.

The MPC 106 also includes a printer interface 166. The printer interface 166 links a printer 169 to the local interface 159. In this respect, the printer interface 166 may be, for example, a printer card or other appropriate buffer circuitry that provides an input/output port such as, for example, a parallel port or a universal serial bus (USB) port, etc. The printer interface 166 may also be, for example, a wireless print interface such as the Bluetooth wireless interface described by Berkema, Alan, et al., Basic Printing Profile, Interoperability Specification, Bluetooth Special Interest Group, Printing Working Group, Revision 0.9, May 25, 2001, the entire specification of which is incorporated herein by reference.

The MPC 106 also includes components that are stored in the memory 156 and are executable by the processor 153. Such components include an operating system 173 and mobile print logic 176. Associated with the MPC 106 and stored in the memory 156 is a mobile printer connector identifier 179 that uniquely identifies the MPC 106 from other mobile printer connectors 106 that may be in data communication with the mobile print server 103 via the networks 109 and 116.

The mobile printing network 100 also includes a mobile device 183, a proxy server 186, and a content server 187. The mobile device 183 may be, for example, a personal digital assistant, a mobile pager, a mobile cellular telephone, or other mobile device with like capability. In this respect, the mobile device 183 includes an electronic mail (“email”) system 189 that may be employed by a user to transmit emails to any other device coupled to the networks 109 and 116 as can be appreciated by those with ordinary skill in the art.

The mobile network 116 may also represent two or more different types of mobile networks to establish communication to and from the mobile device 183 and the mobile printer connector 106. For example, the mobile device 183 may communicate via a cellular network and the mobile printer connector may communicate via a mobile pager network, etc. In such case, the mobile network 116 may represent the cellular network to establish communication with the mobile device 116 as well as a mobile pager network to establish communication with the mobile printer connector 106. Alternatively, the mobile network 116 may be the same for both the mobile device 183 and the mobile printer connector 106, depending upon the particular configuration employed.

The mobile device 183 may also contain one or more documents 193 that may be attached to emails that are then transmitted to a destination address. Alternatively, in the case that the mobile device 183 does not have the capability to store and manipulate documents 193, the documents 193 may be stored in the proxy server 186 and may be manipulated remotely by the mobile device 183. Alternatively, the document 193 may be stored on the content server 186 to be retrieved by the proxy server 186 on behalf of the mobile device 183. For example, the proxy server 186 may include an email interface 196 that provides a user with the ability to generate an email 189 in the mobile device 183 that communicates with the proxy server 186 to attach the document 193 stored in the proxy server 186 thereto and then to transmit such document to an appropriate destination. In this respect, the user of the mobile device 183 may communicate appropriately with the mobile interface 193 by sending an appropriate email using the email system 189 that the document 193 is to be attached and transmitted to an ultimate predefined destination address.

In addition, the mobile print server 103, MPC 106, mobile device 183, and proxy server 186 each may include, for example, various peripheral devices such as a keyboard, keypad, touch pad, touch screen, microphone, scanner, mouse, joystick, or one or more push buttons, etc. The peripheral devices may also include display devices, indicator lights, speakers, printers, etc. Specific display devices may be, for example, cathode ray tubes (CRTs), liquid crystal display screens, gas plasma-based flat panel displays, or other types of display devices, etc.

The memories 126 and 156 are defined herein as both volatile and nonvolatile memory and data storage components. Volatile components are those that do not retain data values upon loss of power. Nonvolatile components are those that retain data upon a loss of power. Thus, each of the memories 126 and 156 may comprise, for example, random access memory (RAM), read-only memory (ROM), hard disk drives, floppy disks accessed via an associated floppy disk drive, compact discs accessed via a compact disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, each of the processors 123 and 153 may represent multiple processors and each of the memories 126 and 156 may represent multiple memories that operate in parallel processing circuits, respectively. In such a case, each of the local interfaces 129 and 159 may be an appropriate network that facilitates communication between any two of the multiple processors, between any processor and any of the memories, or between any two of the memories, etc. The processors 123 and 153 may be electrical or optical in nature.

The operating systems 133 and 173 are executed to control the allocation and usage of hardware resources in the mobile print server 103 and the mobile printer connector 106 such as the memory, processing time and peripheral devices. In this manner, the operating systems 133 and 173 serve as the foundation on which applications depend as is generally known by those with ordinary skill in the art.

Next, a discussion of the operation of the mobile printing network 100 is provided in the context of a print operation where a user of the mobile device 183 seeks to print the document 193, whether it be stored in the mobile device 183 or in the proxy server 196 on the printer 169. Assume, for example, that a user of a mobile device 183 finds themselves at the location of the printer 169, but the mobile device 183 may not have the processing capacity to perform the functions necessary to render the document in the format that is compatible with the printer 169. Alternatively, the required printer driver or other component necessary to render the document 193 in a form that is compatible with the printer 169 may not exist on the mobile device 183. In addition, the mobile device 183 may not include the ability to establish a data communications with the printer 169 in order to be able to print thereon. Specifically, the mobile device 183 may not include the physical interface such as a parallel port, a universal serial bus port, or wireless interface that would allow the mobile device 183 to communicate with the printer 159.

Given that the mobile printer device 183 cannot establish a data communications link with the printer 169, then the user may employ the MPC 106 to enable printing on the printer 169. Specifically, first, the user establishes a data communications link between the MPC 106 and the printer 169. Then, an email is generated and one or more documents to be printed are attached thereto. Thereafter, the email is transmitted to a destination address that is associated with the mobile printer connector service 143. The mobile printer connector service 143 processes the attachment(s), thereby generating a rendered version of the attachment. The mobile printer connector service 143 then transmits the rendered version of the attachment(s) to the MPC 106. The MPC 106 then relays the rendered version of the attachment(s) to the printer 169 for printing.

To explain in more detail, first the user establishes a data communications link between the MPC 106 and the printer 169. This data communications link may be established via a physical connection or a wireless connection between the printer interface 166 and the printer 169. When the physical or wireless connection is established, the mobile printer connector 106 performs hand-shaking and/or other recognition routines with the printer 169 to establish the data communications link therebetween. Once the data communications link is established, then the MPC 106 enters a ready state in which it is then capable of receiving a document and relaying the document to the printer 169. During the initial negotiations between the MPC 106 and the printer 169, the printer supplies a printer identifier to the MPC 106 that is ultimately stored in the memory 156 for future use, as will be described. The printer identifier specifies the model or other information about the printer 169 from which the form of a document to be printed that is compatible therewith may be determined. For example, the printer identifier may specify a print format for documents that is compatible with the printer 169.

Once the user has established the data communications link between the MPC 106 and the printer 169, then the user may employ the mobile device 183 or other device to generate an email to be sent to the destination address 149 that is associated with the MPC service 143. The user attaches one or more documents to the email that are to be printed on the printer 169. Any special printing requirements or settings for the printer 169 are also included in the email. The destination address 149 of the email includes a domain that is associated with the MPC service 143. Also, a mobile printer connector identifier 179 is included in the email that is associated with the MPC 106. This informs the MPC service 143 which MPC 106 is the destination device for a rendered version of the attachment to the email.

The mobile printer identifier 179 may be, for example, a number or other designation as can be appreciated with those with ordinary skill in the art. Assume, for example, that the mobile printer connector identifier 179 is the number “12345” and that the domain associated with the mobile printer connector service 143 is “MPCService.com”. In one embodiment, the user may include the mobile printer connector ID 179 into the destination address of the email such that the ultimate destination address is “12345@MPCService.com”. Alternatively, the mobile printer connector identifier 179 may be included anywhere within the email in such a manner that the MPC service 143 will recognize it upon receiving the email itself.

Once the destination address is included in the email, then the user attaches the document(s) 193 thereto for printing. The email with the attachment(s) is then transmitted to the MPC service 143 on the mobile print server 103. In generating the email, the mobile device 183 may also employ suitable encryption and authentication systems to encrypt and/or otherwise encode the attachment(s) and any other information in the email so as to protect it from interception by unwanted third parties as can be appreciated by those with ordinary skill in the art.

The MPC service 143 may interface with a multitude of MPCs 106 in printing documents for various users. Consequently, when the MPC service 143 receives the email, then the MPC service 143 determines the exact one of the existing MPCs 106 to which the rendered version of the attached document(s) is/are to be transmitted for printing. This is done by obtaining the MPC identifier 179 of the destination MPC 106. According to one aspect of the present invention, the MPC identifier 179 is included in the destination address of the email, thereby providing it directly to the MPC service 143.

Once the destination MPC 106 is known, then the MPC service 143 determines whether the MPC 106 associated with the newly received mobile printer connector identifier 179 is in a state of readiness for printing. The state of readiness is generally achieved when the data communications link is established between the MPC 106 and the printer 169. To determine the state of readiness of the MPC 106, the MPC service 143 transmits a readiness query to the MPC 106 identified by the MPC identifier 179. The specific address on the networks 109 and 116 as well as other information about the MPC 106 may be stored in the memory 126 of the mobile printer server 103 in a database or other data storage format and referenced based upon the MPC identifier 179 to be looked up as necessary.

Upon receipt of the readiness query, if operable, the mobile print logic 176 transmits a readiness reply to the MPC service 143 relaying its precise status. If the MPC 106 is currently disabled or otherwise inoperable, then no reply is generated. In such case, the mobile print connector service 143 times out while waiting for the reply and, thereafter assumes that no reply is forthcoming. In such case, the MPC service 143 transmits a print failure message back to the mobile device 183 or other originating device that was employed to create and transmit the original email with the attached document(s) for printing.

Assuming, however, that the MPC 106 is operable, then upon receiving the readiness request, the mobile print logic 176 generates a readiness reply that indicates “ready” status. The readiness reply is transmitted back to the mobile printer server 103, thereby informing the MPC service 143 that the MPC 106 is ready to receive a rendered version of the attachment(s) for printing on the printer 169. In generating the readiness reply, the MPC 106 includes the printer identifier that was received by the printer 169 during the initial establishment of the data communications link between the MPC 106 and the printer 169. The printer identifier thus informs the MPC service 143 as to the desired format into which the attached document(s) is to be rendered.

Upon receiving the readiness reply that indicates a ready status on the part of the MPC 106, then the MPC service 143 provides the email with the attachment(s) and the printer identifier from the readiness reply to the automated print agent 136. The automated print agent 136 provides for the rendering of the attachment(s) into a format that is compatible with the printer 169, based on the printer identifier supplied thereto. If the readiness reply from the MPC 106 indicates that the MPC 106 is not in a state of readiness, then the MPC service 143 will generate the print failure message and transmit it to the originating device, as was described above.

Upon application of the email with the attachment(s) to the automated print agent 136, the automated print agent 136 then separates the attachment(s) from the email and applies the attachment(s) to the rendering application 139. In doing so, any printer settings or other preferences included in the email are supplied to the rendering application 139 as is necessary to perform a proper rendering of the attachment(s). The rendering application 139 is representative of a number of different rendering applications that may be necessary to render respective documents into the various formats for printing, as can be appreciated by those with ordinary skill in the art. The various formats into which the attachment may be rendered for printing include, for example, Printer Control Language (PCL) 3 or PCL 5 created by Hewlett-Packard Company of Palo Alto, Calif., or Postscript created by Adobe Systems of San Jose, Calif. The specific function of the automated print agent 136 and the rendering application 139 are described in greater detail in co-pending U.S. patent application entitled “System and Method for Mobile Printing,” assigned Ser. No. 09/884,594, filed on Jun. 18, 2001; co-pending U.S. patent application entitled “System and Method for Walk-Up Printing,” assigned Ser. No. 09/884,318, filed on Jun. 18, 2001; co-pending U.S. patent application entitled “Rendering Broker Service and Method,” assigned Ser. No. 09/884,593, filed on Jun. 18, 2001; co-pending U.S. patent application entitled “System and Method for Automated Rendering to Print to a File,” assigned Ser. No. 09/884,249, filed on Jun. 18, 2001; co-pending U.S. patent application entitled “System and Method for Remote Document Retrieval,” assigned Ser. No. 09/884,600, filed on Jun. 18, 2001; and co-pending U.S. patent application entitled “System and Method for Configuring a Printing System,” assigned Ser. No. 09/884,598, filed on Jun. 18, 2001, the entire text and drawings of the above cited U.S. patent applications being incorporated herein by reference.

Once the automated print agent 136 obtains the rendered version of the attachment(s), it provides the same to the MPC service 143 to transmit to the designated MPC 106. The MPC service 143 then transmits the rendered version of the attachment to the MPC 106 for printing. Upon receiving the rendered version of the attachment, the mobile print logic 176 then proceeds to relay the attachment to the printer 169 that prints the document accordingly. The MPC 106 may not receive the entire attachment before it begins transmission of the same to the printer 169. In this respect, a portion of the memory 156 may be employed as a data buffer to store at least a portion of an attachment during the printing process. Such may specifically be the case if any attachment is a large document requiring significant amounts of memory that are greater than the size of the memory 156. Thus, as referred to herein, the function of “receiving” an item is defined as accepting and storing data transmitted by another device. The data received may comprise an entire data file or a portion thereof.

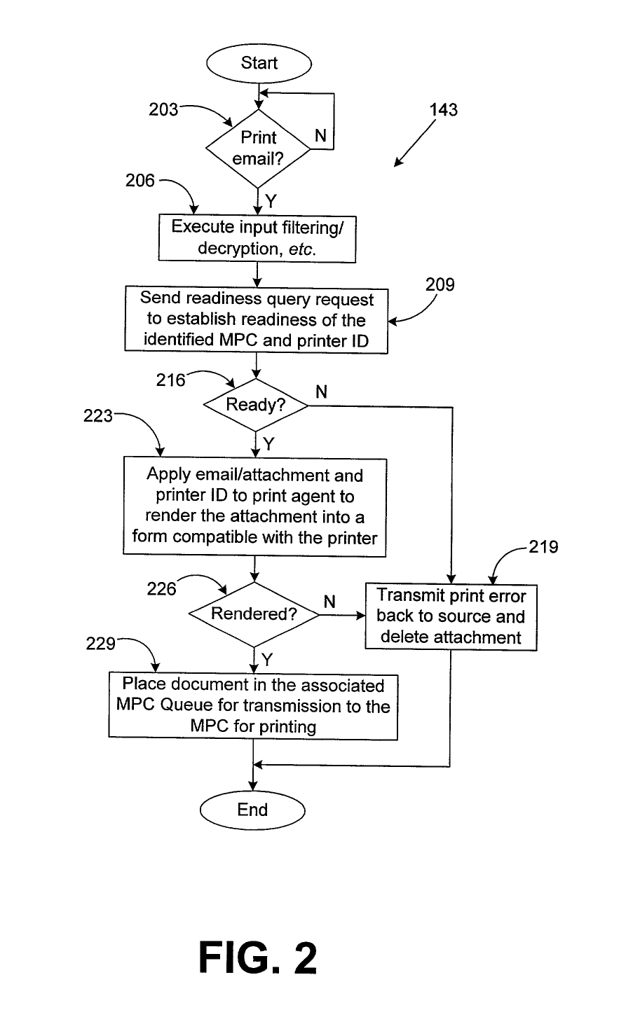

With reference to FIG. 2, shown is a flowchart of the MPC service 143 according to an aspect of the present invention. Alternatively, the flowchart of FIG. 2 may be viewed as depicting steps in a method implemented in the mobile print server 103 (FIG. 1) according to an aspect of the present invention.

Beginning with block 203, the MPC service 143 first determines whether an email with one or more attachment(s) for printing has been received from a mobile device 183 or other device coupled to the networks 109 or 116. If such is the case, then the MPC service 143 proceeds to box 206 in which appropriate input filtering, decryption, authentication, and other utilities are performed. The filtering tasks may include, for example, a blocking task that restricts access to the corresponding printer to select users in cases where various organizations wish to limit the ability of individuals to print on a particular printer. This may be done, for example, by examining the “from” field in a particular email message to determine if the message was sent by an authorized user. Also, other security access technology may be employed to restrict the access to specific users such as, for example, employing security codes or other such approaches. In addition, the filtering tasks may include scanning for viruses in the attachment and in the email, as well as performing authentication routines to ensure that the user who sent the email message with the attached document is the person that he or she represents himself or herself to be. To accomplish the virus scanning and authentication tasks, various technologies that are generally available on the market may be employed as is generally known by those with ordinary skill in the art.

The MPC service 143 then proceeds to box 209 in which a readiness request is transmitted to the MPC 106 to establish the state of readiness of the MPC 106 and to obtain the printer identifier associated with the printer 169 (FIG. 1) upon which the attachment(s) is/are to be printed so that the attachment(s) may be rendered in a format that is compatible with the printer 169 (FIG. 1).

In box 216, the MPC service 143 waits to receive a readiness reply from the MPC 106 indicating that it is ready to receive the rendered version of the attachment(s) for printing. If a predetermined time period passes without receiving the readiness reply, then in box 216 the MPC service 143 assumes that the MPC 106 is inoperable and proceeds to box 219. If a readiness reply is received from the MPC 106 indicating that the MPC 106 is not in a state of readiness, then the MPC service 143 also proceeds to box 219.

In box 219, the MPC service 143 generates a print error message that is transmitted back to the originator of the email such as, for example, the mobile device 183 (FIG. 1), thereby informing the user of such device that the print function was not possible. Thereafter, the MPC service 143 ends as shown.

However, assuming in box 216 that a readiness reply was received from the MPC 106 that indicates that the MPC 106 is in a ready state for printing, then the MPC service 143 proceeds to box 223. In performing the acts necessary to establish that the MPC 106 is in a ready state, the MPC service 143 and the MPC 106 establish a print session in which one or more documents contained in the attachments are printed.

In box 223 the email with the attachment(s) and the printer identifier received in the readiness reply, is provided to the automated print agent 136 that orchestrates the rendering of the attachment(s) into a format that is compatible with the printer 169 (FIG. 1). Thereafter in box 226, the MPC service 143 waits to receive a rendered version of the attachment for printing from the automated print agent 136. If the rendering function cannot be performed for some reason, then the MPC service 143 moves to box 219. Such may be the case, for example, if the precise rendering application 139 that is necessary to render the attachment(s) into the format for printing on the printer 169 is not available or if some other error condition occurs in the operation of the automated print agent 136 or the rendering application 139.

On the other hand, assuming that the attachment(s) is/are rendered in the format that is compatible with the printer 169, then the MPC service 143 proceeds to box 229. In box 229 the rendered version of the attachment(s) is/are placed in the MPC queue 146 (FIG. 1) that is associated with the MPC 106. Thereafter, the MPC service 143 transmits the rendered version of the attachment(s) to the MPC 106. If more than one rendered attachment are placed in the MPC queue 146, then each rendered attachment is transmitted to the MPC 106 in succession. Then, MPC service 143 ends as shown.

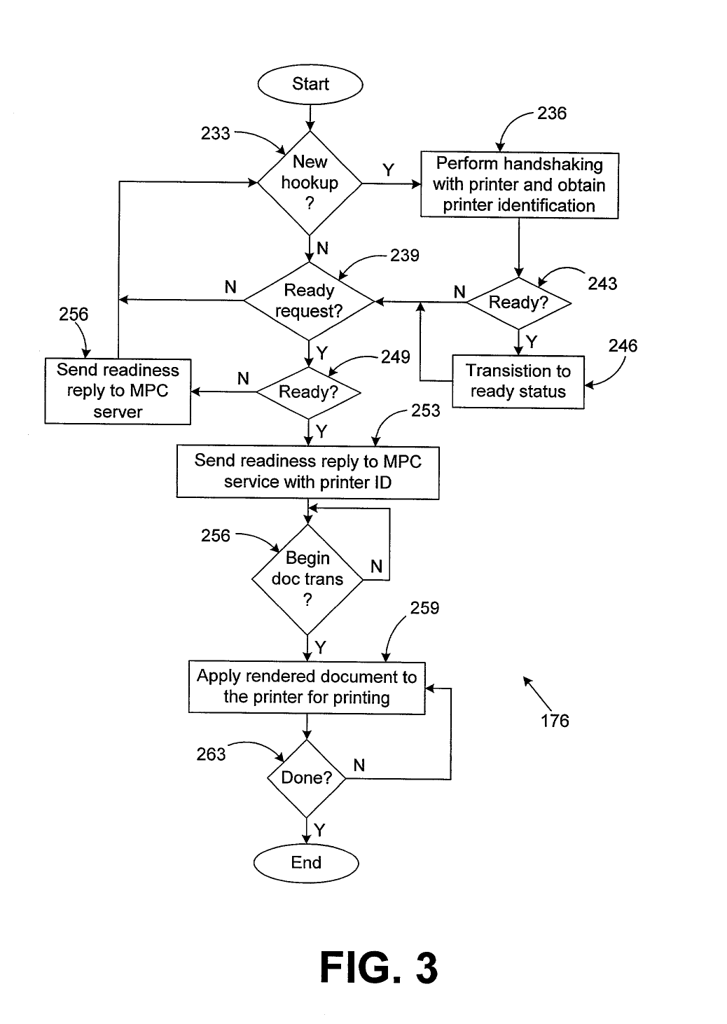

With reference to FIG. 3, shown is a flowchart of the mobile print logic 176 according to an aspect of the present invention. Alternatively, the flowchart of FIG. 3 may be viewed as depicting steps in a method that is implemented in the MPC 106 (FIG. 1). The mobile print logic 176 is executed in performing the functions of the MPC 106. In this respect, the mobile print logic 176 begins with box 233 in which it is determined that a new hook-up or linkage is to be created with a specified printer 169 (FIG. 1). This might occur, for example, when a user attaches data communications cables such as a parallel or serial cable between the MPC 106 and the printer 169. Alternatively, the MPC 106 may automatically establish wireless communications with the printer 169 when in close proximity thereto as provide by the Bluetooth specification referenced above. In any event, whether a physical or wireless coupling is established, ultimately the data communications link between the MPC 106 and the printer 169 is possible. If a new hook-up is detected, then the mobile print logic 176 proceeds to box 236 in which appropriate hand-shaking operations are performed with the printer 169 and the printer identification is obtained therefrom. If no new hook-up is detected in box 233, then the mobile print logic 176 proceeds to box 239.

From box 236, the mobile print logic 176 proceeds to box 243 in which it is determined whether the data communications link has been established between the MPC 106 and the printer 169. If such is the case then the mobile print logic 176 proceeds to box 246 in which the MPC 106 transitions to a ready status for future potential communication with the MPC service 143 (FIG. 1) as described previously. If the MPC 106 fails to establish the data communications link with the printer 169 in box 243 or assuming that the MPC 106 had previously transitioned to ready status in box 246, then the mobile print logic 176 proceeds to box 239.

In box 239 the mobile print logic 176 determines whether a readiness request has been received from the MPC service 143. If not, then the mobile print logic 176 reverts back to box 233. On the other hand, if such a query has been received, the mobile print logic 176 proceeds to box 249 in which the mobile print logic 176 determines whether the MPC 106 is in a ready state. If so, then the mobile print logic 176 proceeds to box 253. Otherwise, the mobile print logic 176 proceeds to box 256. In box 256, a readiness reply is generated and sent back to the MPC service 143 informing the MPC service 143 that the MPC 106 is not in a readiness state to facilitate printing of the attachment(s). Thereafter, the mobile print logic 176 reverts back to box 233 as shown.

Assuming however, that the MPC 106 is in a ready state in box 249, then the mobile print logic 176 proceeds to box 253 in which a readiness reply is transmitted to the mobile printer connector service 143. The printer identifier of the printer 169 upon which the attachment(s) is/are to be printed is included in the readiness reply so that the precise rendering operations to be performed can be determined at the mobile print server 103.

Thereafter, in box 256 the mobile print logic 176 waits to receive the rendered version of the attachment(s) for printing from the MPC service 143 for application to the printer 169 for printing. Assuming that transmission of the rendered version of the attachment(s) has begun, then the mobile print logic 176 proceeds to box 259 to apply the rendered version of the attachment(s) to the printer 169 for printing. In performing this task, the mobile print logic 176 may store a current portion of the document in the memory 156 while transmitting to the printer 169. In this regard, the MPC service 143 may transmit the document for printing in a series of packets of predefined size that are acknowledged as received by the mobile print logic 176. In box 263, the mobile print logic 176 determines whether the print operation is complete. If not, then the mobile print logic 176 reverts back to box 259. Otherwise, the mobile print logic 176 ends accordingly.

In addition, the MPC service 143 and the mobile print logic 176 may employ various security measures in communicating with each other such as data encryption, authentication, and other security measures as can be appreciated by one with ordinary skill in the art.

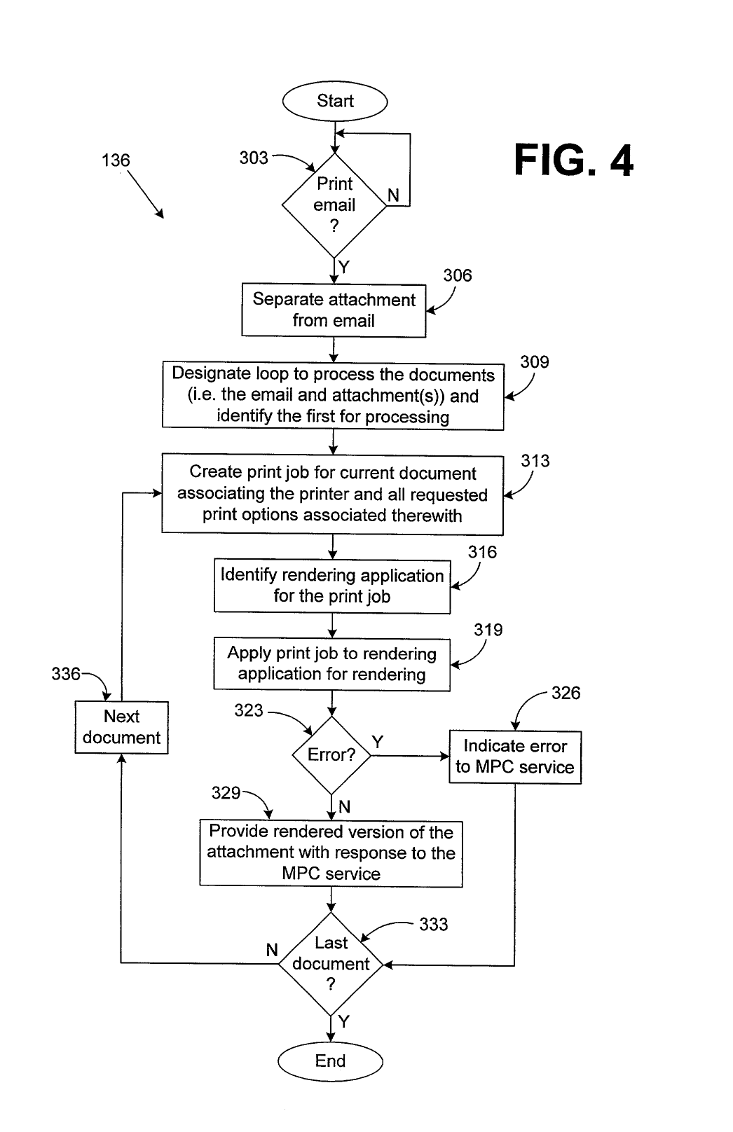

With specific reference to FIG. 4, shown is a flow chart of the operation of the automated print agent 136 according to an aspect of the present invention. Alternatively, the flow chart of FIG. 4 may be viewed as depicting steps in a method implemented in the mobile print server 103. Beginning with box 303, the automated print agent 136 determines whether the MPC service 143 has provided an email message with an attached document to be printed along with the printer identifier. Thereafter, the automated print agent 136 proceeds to box 306 in which the email message is separated from the one or more attachments from the email message that was received. Note that this may be accomplished employing various components of the JavaX.mail libraries that are commercially available. The JavaX.mail libraries are created and marketed by Sun MicroSystems, Inc., of Palo Alto, Calif.

The automated print agent 136 then proceeds to box 309 in which a loop is designated to process and print the email message and the one or more attachments. In this respect, the email message and each of the attachments are separated into separate “documents” for printing. In this regard, a document is defined as either the email itself or as one of the attachments that is to be printed separately on the respective printer 169 through the MPC 106. In designating a loop to process each one of these documents in box 309, the first document, usually the email message, is designated for processing.

Thereafter, in box 313 a print job is created for the current document that has been identified for processing. The type of printer 169 to be used in printing the document as determined from the printer identifier provided by the MPC service 143 is associated with the print job. Also any requested print options that are included in the email message are also associated with the print job in order to provide for proper rendering of the document. Specifically, the type or model of printer is to be provided to the rendering application 139 (FIG. 1) in order to render the document in a format that is compatible with the printer 169. Also if there are any print options that have been specified by the user of the mobile device 183 that are to be adhered to in rendering the document, such information is included in the print job accordingly.

The automated print agent 136 then proceeds to box 316 in which a rendering application 139 is identified to render the print job in a printer ready format. In order to make this determination, the automated print agent 136 may include a rendering lookup table that provides the ability to determine the name and location of a specific rendering application 139 in the case that several different rendering applications 139 exist from which to choose. Alternatively, a single rendering application 139 may be employed. When the proper rendering application 139 is identified, then in box 319 the print job is applied to the appropriate rendering application 139 to be rendered in the printer ready format. Such a printer ready format may include, for example, printer control language (PCL) or PostScript. Note there may be other printer formats that are rendered by a particular rendering application 139 as can be appreciated by one with ordinary skill in the art.

In box 323, the automated print agent 136 waits for the return of the rendered print job from the rendering application 139. If the rendered print job fails to return within a predefined timeout period, then a rendering error is assumed to have occurred and the automated print agent 136 proceeds to box 326. Also, if the rendering application 139 returns with an error message indicating that rendering of the print job was not possible, the automated print agent 136 also proceeds to box 326. On the other hand, if the rendering of the print job was successful, then the rendering application 139 returns the rendered print job and the automated print agent 136 proceeds to box 329.

Assuming the automated print agent 136 reaches box 326, then a message is provided to the MPC service 143 that details the precise nature of the error. The MPC service 143 may then compose the error message that is sent to the originator of the email as discussed in box 219 (FIG. 2). Thereafter, the automated print agent 136 proceeds to box 333.

On the other hand, assuming that the automated print agent 136 has proceeded to box 329 after a successful rendering of the print job, then the automated print agent 136 returns the successfully rendered document to the MPC service 143 to send to the MPC 106 as was described with reference to box 229 (FIG. 2). Then, in box 333 it is determined whether the last document has been processed in the current loop designated in box 309. If not then the automated print agent 136 moves to box 336 in which the next document is designated for processing. Thereafter, the automated print agent 136 reverts to box 316 to repeat the process for the next document. Otherwise, the automated print agent 136 ends as shown.

Although the MPC service 143, mobile print logic 176, and automated print agent 136 of the present invention is embodied in software or code executed by general purpose hardware as discussed above, as an alternative the same may also be embodied in dedicated hardware or a combination of software/general purpose hardware and dedicated hardware. If embodied in dedicated hardware, the MPC service 143, mobile print logic 176, and automated print agent 136 can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

The flow charts of FIGS. 2-4 show the architecture, functionality, and operation of an implementation of the MPC service 143, mobile print logic 176, and automated print agent 136. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flow charts of FIGS. 2-4 show a specific order of execution, it is understood that the order of execution may differ from that which is depicted. For example, the order of execution of two or more blocks may be scrambled relative to the order shown. Also, two or more blocks shown in succession in FIGS. 2-4 may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present invention. Also, the flow charts of FIGS. 2-4 are relatively self-explanatory and are understood by those with ordinary skill in the art to the extent that software and/or hardware can be created by one with ordinary skill in the art to carry out the various logical functions as described herein. Also, where the MPC service 143, mobile print logic 176, and automated print agent 136 comprises software or code, it can be embodied in any computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present invention, a “computer-readable medium” can be any medium that can contain, store, or maintain the MPC service 143, mobile print logic 176, and automated print agent 136 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, or compact discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Although the invention is shown and described with respect to certain preferred embodiments, it is obvious that equivalents and modifications will occur to others skilled in the art upon the reading and understanding of the specification. The present invention includes all such equivalents and modifications, and is limited only by the scope of the claims.

What is claimed is:

1. A printing method, comprising:
establishing a data communications link between a mobile printer connector and a printer;
transmitting an email with an attachment for printing to a mobile print connector service;
receiving the attachment embodied in a format recognizable by the printer in the mobile printer connector; and
relaying the attachment embodied in the format recognizable by the printer from the mobile printer connector to the printer for printing.

2. The method of claim 1, wherein the step of establishing the data communications link between the mobile printer connector to the printer further comprises performing a handshaking operation between the mobile printer connector and the printer.

3. The method of claim 2, wherein the step of performing the handshaking operation between the mobile printer connector and the printer further comprises:
querying the printer for a printer identification; and
storing the printer identification in the mobile printer connector that was received from the printer.

4. The method of claim 1, wherein the step of transmitting the email with the attachment for printing to the mobile print connector service further comprises:
generating the email;
addressing the email to an alias associated with the mobile print connector service, the alias including a mobile printer connector designation associated with the mobile printer connector;
attaching a document to the email as the attachment; and
transmitting the email.

5. The method of claim 1, further comprising:
establishing a print session with the mobile print connector service; and
transmitting a printer identification to the mobile print connector service.

6. The method of claim 5, wherein the step of establishing the print session with the mobile print connector service further comprises responding to a readiness query from the mobile print connector service with a readiness status of the mobile printer connector.

7. The method of claim 1, wherein the step of relaying the attachment embodied in the format recognizable by the printer from the mobile printer connector to the printer for printing further comprises buffering at least a portion of the attachment embodied in the format recognizable by the printer in the mobile printer connector.

8. A mobile printer connector, comprising:
a processor circuit having a processor and a memory;
a wireless transceiver coupled to the processor circuit;
a printer interface coupled to the processor circuit;
mobile print logic stored in the memory and executable by the processor, the mobile print logic comprising:
logic that establishes a data communications link with a printer;
logic that establishes a print session with a mobile print connector service; and
logic that relays a document received via the wireless transceiver to the printer via the printer interface.

9. The mobile printer connector of claim 8, wherein the mobile print logic further comprises logic that provides for a buffering of at least a portion of the document in the memory.

10. The mobile printer connector of claim 8, wherein the logic that establishes the data communications link with the printer further comprises logic that obtains a printer identification from the printer.

11. The mobile printer connector of claim 8, wherein the logic that establishes the print session with the mobile print connector service further comprises logic that responds to a readiness query from the mobile print connector service with a readiness status of the mobile printer connector.

12. A mobile printer connector, comprising:
means for establishing a communications link with a mobile print connector service;
means for establishing a data communications link with a printer;
means for performing a handshaking routine with the printer;
means for establishing a print session with a mobile print connector service; and
means for relaying a document received via the wireless communications link to the printer.

13. The mobile printer connector of claim 12, wherein the means for relaying the document received via the wireless communications link to the printer further comprises means for buffering at least a portion of the document in the mobile printer connector.

14. The mobile printer connector of claim 12, wherein the means for establishing a data communications link with a printer further comprises means for obtaining a printer identification from the printer.

15. The mobile printer connector of claim 12, wherein the means for establishing the print session with the mobile print connector service further comprises means for responding to a readiness query from the mobile print connector service with a readiness status of the mobile printer connector.

16. A method to facilitate mobile printing, comprising:
receiving in a server an email with an attachment that is to be printed;
identifying a mobile printer connector designated as a print receptor for the attachment;
obtaining a rendered version of the attachment for printing; and
transmitting the rendered version of the attachment to the mobile printer connector for printing.

17. The method of claim 16, wherein the step of receiving in the server the email with the attachment that is to be printed further comprises:
associating a domain name with the server; and
receiving the email addressed with an alias that includes the domain name.

18. The method of claim 16, further comprising placing the rendered version of the attachment into a printing queue associated with the mobile printer connector for transmission to the mobile printer connector.

19. The method of claim 16, further comprising:
determining a print error condition; and
transmitting a print error message to a device that originated the email.

20. The method of claim 16, wherein the step of obtaining the rendered version of the attachment for printing further comprises:
transmitting the attachment to a remote rendering device to be rendered; and
receiving a rendered version of the attachment from the remote rendering device.

21. The method of claim 16, wherein the step of obtaining the rendered version of the attachment for printing further comprises performing a rendering operation to convert the attachment from a predefined version into the rendered version for printing.

22. The method of claim 16, further comprising determining a readiness status of the mobile printer connector.

23. The method of claim 22, wherein the step of determining the readiness status of the mobile printer connector further comprises:
transmitting a readiness query to the mobile printer connector; and
receiving the readiness status from the mobile printer connector.

24. The method of claim 16, wherein the step of identifying the mobile printer connector designated as the print receptor for the attachment further comprising obtaining a mobile printer connector identifier from the email.

25. The method of claim 24, wherein the step of obtaining the mobile printer connector identifier from the email further comprises obtaining the mobile print connector identifier from a destination address of the email.

26. The method of claim 16, further comprising determining a printer identifier from the mobile printer connector that indicates a type of printer that is in data communication with the mobile printer connector.

27. The method of claim 26, wherein the step of obtaining the rendered version of the attachment for printing further comprises rendering the attachment into a language compatible with the type of printer.

28. A program embodied in a computer readable medium that facilitates mobile printing, comprising:
code that identifies a mobile printer connector designated as a print receptor for an attachment to an email received from a sending device, wherein the attachment is to be printed;
code that obtains a rendered version of the attachment for printing; and
code that transmits the rendered version of the attachment to the mobile printer connector for printing.

29. The program embodied in a computer readable medium of claim 28, further comprising code that places the rendered version of the attachment into a printing queue associated with the mobile printer connector for transmission to the mobile printer connector.

30. The program embodied in a computer readable medium of claim 28, further comprising:
code that determines a print error condition; and
code that transmits a print error message to the sending device.

31. The program embodied in a computer readable medium of claim 28, where in the code that obtains the rendered version of the attachment for printing further comprises code that transmits the attachment to a remote rendering device with a request to render the attachment in the rendered version for printing.

32. The program embodied in a computer readable medium of claim 28, wherein the code that obtains the rendered version of the attachment for printing further comprises code that renders the attachment from a predefined version into the rendered version for printing.

33. The program embodied in a computer readable medium of claim 28, further comprising code that determines a readiness status of the mobile printer connector.

34. The program embodied in a computer readable medium of claim 33, wherein the code that determines the readiness status of the mobile printer connector further comprises code that transmits a readiness query to the mobile printer connector, thereby prompting a response from the mobile printer connector indicating the readiness status thereof.

35. The program embodied in a computer readable medium of claim 28, wherein the code that identifies the mobile printer connector designated as the print receptor for the attachment to the email received from the sending device further comprises code that obtains a mobile printer connector identifier from the email.

36. The program embodied in a computer readable medium of claim 35, wherein the code that obtains the mobile printer connector identifier from the email further comprises code that obtains the mobile print connector identifier from a destination address of the email.

37. The program embodied in a computer readable medium of claim 28, further comprising code that obtains a printer identifier from the mobile printer connector, the printer identifier indicating a type of printer that is in data communication with the mobile printer connector.

38. The program embodied in a computer readable medium of claim 37, wherein code that obtains the rendered version of the attachment for printing further comprises code that renders the attachment into a language compatible with the type of printer.

39. A system that facilitates mobile printing, comprising:
means for identifying a mobile printer connector designated as a print receptor for an attachment to an email received from a sending device, wherein the attachment is to be printed;
means for obtaining a rendered version of the attachment for printing; and
means for transmitting the rendered version of the attachment to the mobile printer connector for printing.

40. The system of claim 39, further comprising means for determining a readiness status of the mobile printer connector.

41. The system of claim 39, further comprising:
means for determining a print error condition; and
means for transmitting a print error message to the sending device.

42. The system of claim 39, wherein the means for obtaining the rendered version of the attachment for printing further comprises means for transmitting the attachment to a remote rendering device with a request to render the attachment in the rendered version for printing.

43. The system of claim 39, wherein the means for obtaining the rendered version of the attachment for printing further comprises means for rendering the attachment from a predefined version into the rendered version for printing.

44. The system of claim 39, wherein the means for identifying the mobile printer connector designated as the print receptor for the attachment to the email received from the sending device further comprises means for obtaining a mobile printer connector identifier from the email.

45. The system of claim 39, further comprising means for obtaining a printer identifier from the mobile printer connector, the printer identifier indicating a type of printer that is in data communication with the mobile printer connector.

46. The system of claim 45, wherein means for obtaining the rendered version of the attachment for printing further comprises means for rendering the attachment into a language compatible with the type of printer.
